(19) United States
(12) Patent Application Publication
(10) Pub. No.: US 2026/0074947 A1
(43) Pub. Date: Mar. 12, 2026

(54) Intelligent network incident management, root cause analysis, and automated remediation

(71) Applicant: Zscaler, Inc., San Jose, CA (US)

(72) Inventors: Rosh Ramadass, Mountain House, CA (US); Sasamka Mone, San Ramon, CA (US)

(73) Assignee: Zscaler, Inc., San Jose, CA (US)

(21) Appl. No.: 18/826,888

(22) Filed: Sep. 6, 2024

(51) Int. Cl. H04L 41/0631

(52) U.S. Cl. CPC H04L 41/0631

(57) ABSTRACT

Systems and methods for intelligent network incident management, Root Cause Analysis (RCA), and automated remediation include receiving metrics, graphs, and historic logs associated with network performance of a tenant of the cloud system; identifying a network issue based on the received metrics, graphs, and historic logs; performing an automated RCA to determine a cause of the network issue; and remediating the identified network issue based on the determined cause. Various embodiments include training specialized Large Language Models (LLMs) for performing the automated incident identification, RCA, and remediation.

### FIELD OF THE DISCLOSURE

The present disclosure generally relates to network and cloud security. More particularly, the present disclosure relates to intelligent network incident management, root cause analysis, and automated remediation.

### BACKGROUND OF THE DISCLOSURE

Root cause analysis (RCA) and remediation in networks are essential for maintaining IT infrastructure stability and performance. RCA involves identifying the underlying reasons for network issues like outages or performance degradation, aiming to resolve them permanently. The process starts with data collection from network components, followed by event correlation and analysis using historical data and advanced tools. Administrators then test hypotheses to confirm the root cause and implement remediation, such as configuration changes or software updates, to prevent recurrence. Despite the complexity of modern networks, effective RCA minimizes downtime, ensures continuous service, and helps meet service level agreements (SLAs). A significant problem with current RCA methods is their reliance on manual processes and human expertise, which can be time-consuming, error-prone, and difficult to scale in complex, modern network environments. Based on this, the present disclosure provides systems and methods for intelligent network incident management, RCA, and automated remediation.

### BRIEF SUMMARY OF THE DISCLOSURE

The present disclosure relates to systems and methods for intelligent network incident management, root cause analysis, and automated remediation. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving metrics, graphs, and historic logs associated with network performance of a tenant of the cloud system; identifying a network issue based on the received metrics, graphs, and historic logs; performing an automated Root Cause Analysis (RCA) to determine a cause of the network issue; and remediating the identified network issue based on the determined cause.

The steps can further include wherein the graphs include metric trends over a period of time. The remediation can be performed automatically based on one or more remediation scripts. Identifying the network issue can be based on one or more metric thresholds. The one or more metric thresholds can be dynamic, wherein the steps include adjusting the one or more metric thresholds via a trained Large Language Model (LLM). The metrics, graphs, and historic logs can be received from one or more cloud connectors. The one or more cloud connectors can be associated with any of computing devices and enterprise networks. The identifying a network issue, performing automated RCA, and remediating can each be performed by one or more trained Large Language Models (LLMs). The steps can include training a first LLM to perform automated identification of network issues; training a second LLM to perform automated RCA; and training a third LLM to perform automated remediation of identified network issues. The tenant can be one of a plurality of tenants of the cloud system, wherein the one or more LLMs are trained based on tenant-specific metrics, graphs, and historic logs.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIGS. 5-18 are various screenshots of a Graphical User Interface (GUI) associated with the analysis service to display, report, and provide a drill-down of the User Experience (UEX) scores.

FIG. 19 is a flow diagram of the present observability metrics pipeline architecture.

FIG. 20 is a flow diagram of a process for training a model to perform automated RCA.

FIG. 21 is a flow diagram of a process for training a model to perform automated remediation.

FIG. 22 is a flow diagram of a process for generating automated RCAs.

FIG. 23 is a flow diagram of a process for performing and generating automated remediation.

FIG. 24 is a flow diagram of a process for automated threshold configuration.

FIG. 25 is a flow chart of a process for performing intelligent network incident management, root cause analysis, and automated remediation.

### DETAILED DESCRIPTION OF THE DISCLOSURE

Again, the present disclosure relates to systems and methods for intelligent network incident management, Root Cause Analysis (RCA), and automated remediation. Various embodiments include training specialized Large Language Models (LLMs) for performing automated incident identification, RCA, and remediation. These models can be fed tenant-specific metrics, graphs, and historic data in order to determine when issues are occurring and determine causes for the issues. Further, a plurality of remediation scripts can be leveraged by the models to perform automatic remediation based on the determined cause of an issue.

### § 1.0 Cybersecurity Monitoring and Protection Examples

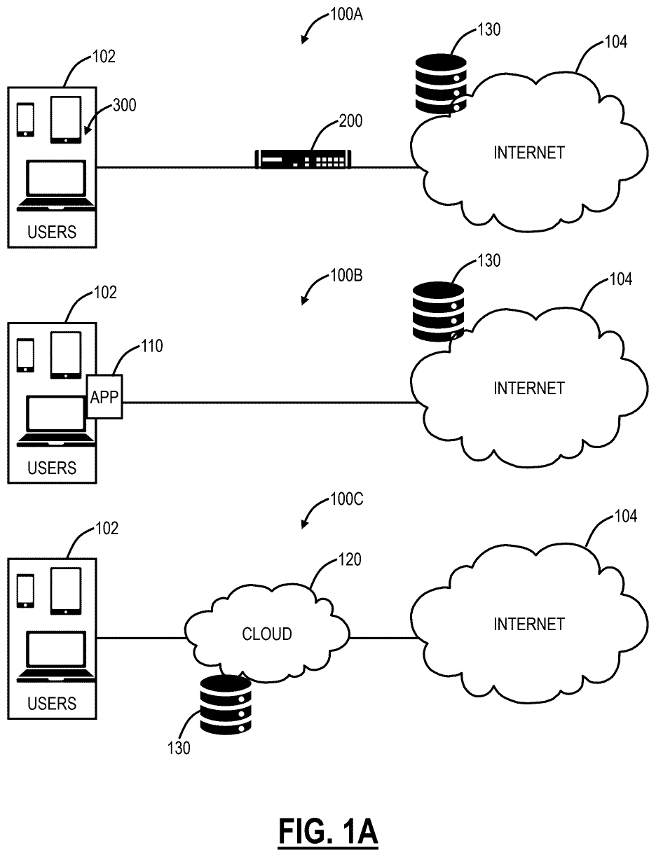

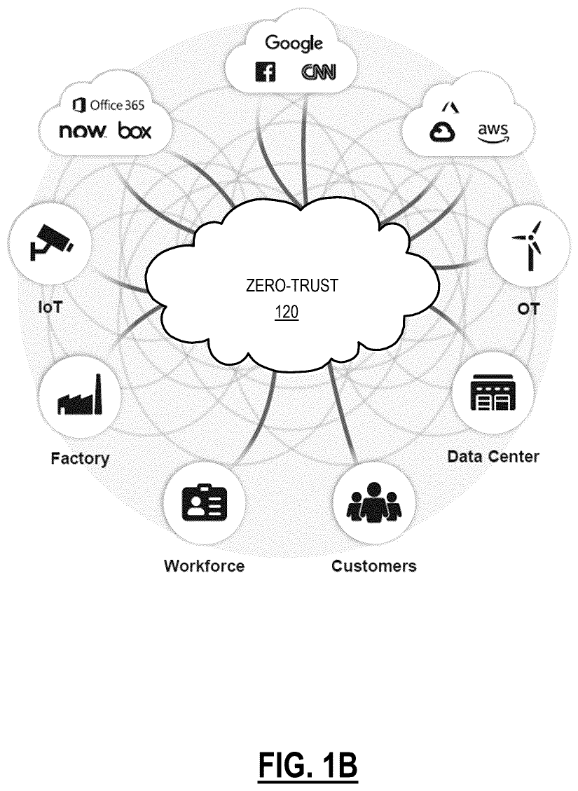

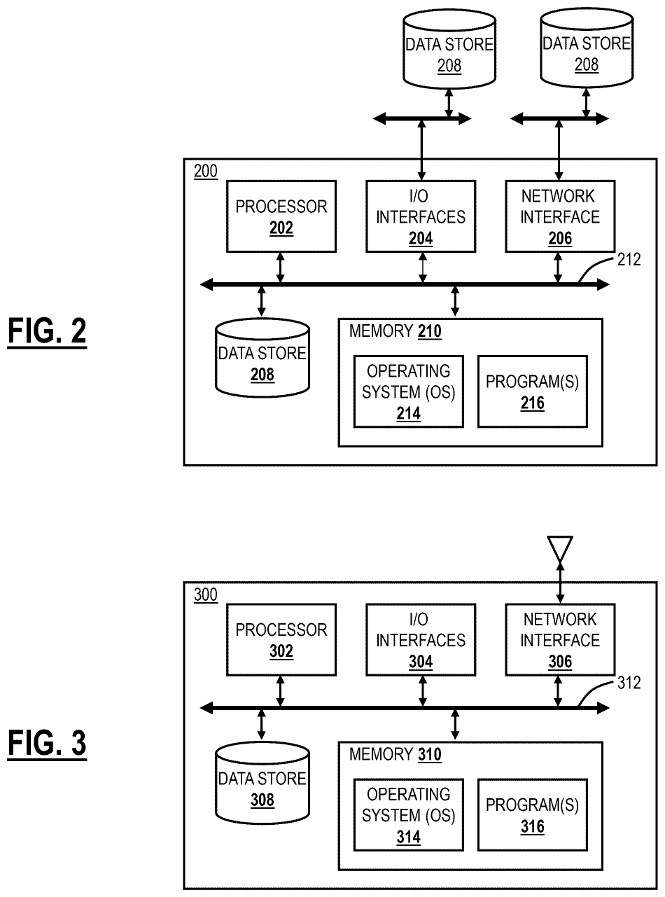

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### $2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.,

### $3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### $4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

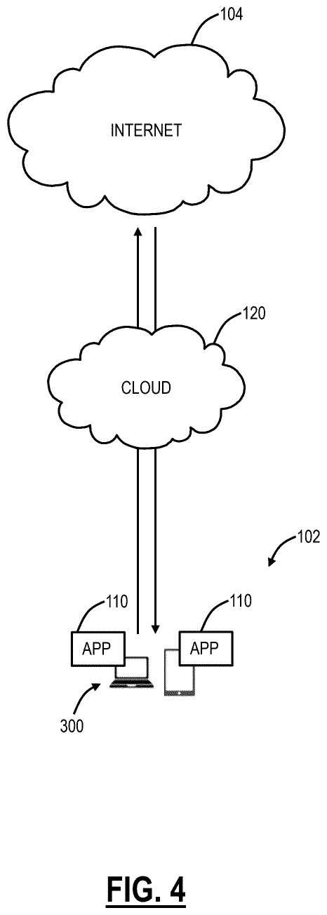

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### $5.0 Digital Experience Monitoring

As described, the cloud 120 provides security as a service as well as Zero Trust Network Access (ZTNA) to provide real-time, continuous digital experience monitoring, as opposed to conventional approaches (synthetic probes). A key aspect of the architecture of the cloud 120 is the inline monitoring. This means data is accessible in real-time for individual users from end-to-end. As described herein, digital experience monitoring can include monitoring, analyzing, and improving the digital user experience.

The cloud 120 connects users 102 to applications, the Internet 104, cloud services, etc. The inline, end-to-end visibility of all users enables digital experience monitoring. The cloud 120 can monitor, diagnose, generate alerts, and perform remedial actions with respect to network endpoints, network components, network links, etc. The network endpoints can include servers, virtual machines, containers, storage systems, or anything with an IP address, including the Internet of Things (IoT), cloud, and wireless endpoints. With these components, these network endpoints can be monitored directly in combination with a network perspective. Thus, the cloud 120 provides a unique architecture that can enable digital experience monitoring, network application monitoring, infrastructure component interactions, etc. Of note, these various monitoring aspects require no additional components—the cloud 120 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud 120 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud 120 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud 120 can operate at 10 gigabits (10G) Ethernet and higher at full line rate and support a rate of 100,000 or more flows per second or higher.

The applications accessible by the users 102 can include enterprise applications, Office 365, Salesforce, Skype, Google apps, internal applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 110 or the cloud edge to quantify user experience for specific applications, i.e., the application-related and device-related data. The cloud 120 can further collect the network-related and the protocol-related data (e.g., Domain Name System (DNS) response time).

Metrics could be combined. For example, device health can be based on a combination of CPU, memory, etc. Network health could be a combination of Wi-Fi/LAN connection health, latency, etc. Application health could be a combination of response time, page loads, etc. The cloud 120 can generate service health as a combination of CPU, memory, and the load time of the service while processing a user's request. The network health could be based on the number of network path(s), latency, packet loss, etc.

A lightweight connector located in front of applications can also generate similar metrics for the applications. In an embodiment, the metrics can be collected while a user is accessing specific applications that user experience is desired for monitoring. In another embodiment, the metrics can be enriched by triggering synthetic measurements in the context of an inline transaction by the application 110 or cloud edge. The metrics can be tagged with metadata (user, time, app, etc.) and sent to a logging and analytics service for aggregation, analysis, and reporting. Further, network administrators can get UEX reports from the cloud 120. Due to the inline nature and the fact the cloud 120 is an overlay (in-between users and services/applications), the cloud 120 enables the ability to capture user experience metric data continuously and to log such data historically. As such, a network administrator can have a long-term detailed view of the network and associated user experience.

### $5.1 Digital Experience Monitoring

The applications and the SaaS can include enterprise applications, Office 365, Salesforce, Skype, internal applications, etc. These are critical business applications where user experience is important. The objective here is to collect various data points so that user experience can be quantified for a particular user, at a particular time, for purposes of analyzing the experience as well as improving the experience.

In an embodiment, the monitored data can be from different categories including application-related, network-related, device-related (also can be referred to as endpoint-related), protocol-related, etc. Data can be collected at the application 110 or the cloud edge to quantify user experience for specific applications, i.e., the application-related and device-related data. The cloud 120 can further collect the network-related and the protocol-related data (e.g., Domain Name System (DNS) response time).

### Application-Related Data

| | |
|---|---|
| Page Load Time | Redirect count (#) |
| Page Response Time | Throughput (bps) |
| Document Object Model (DOM) Load Time | Total size (bytes) |
| Total Downloaded bytes | Page error count (#) |
| App availability (%) | Page element count by |
| | category (#) |

### Network-Related Data

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

### Device-Related Data (Endpoint-Related Data)

| | |
|---|---|
| System details | Network (config) |
| Central Processing Unit (CPU) | Disk |
| Memory (RAM) | Processes |
| Network (interfaces) | Applications |

An example of HTTP Request metrics includes CONNECT, time to first byte/first 10 bytes, time to last byte, Secure Sockets Layer (SSL) handshake time, etc. For example, HTTP can be used to send probes to take measurements.

For example, browser triggered data can include collection when a user visits a domain or subnet. The page load performance data can be sampled using the W3C standard HTTP Archive format (HAR). For each session or sample, the agent application 110 can collect: a device fingerprint profile including: 1) IP/DNS configuration (private/public IP, gateway, etc.), 2) Wired or Wi-fi connection (link speed, signal quality, Service Set Identifier (SSID), Basic SSID (BSSID), etc.), 3) VPN config if possible (from routing table, VPN service), 4) Proxy config (cloud or other, parse Proxy Auto Config (PAC) files), and 5) System metrics (CPU, Mem, Swap, bytes in/out etc.). The device fingerprint profile can also include test probes such as a Ping (Internet Control Message Protocol (ICMP)) to discovered gateway, destination, VPN and/or Proxy, and Traceroute (ICMP/Transmission Control Protocol (TCP)) to discovered gateway, destination, VPN and/or Proxy.

Metrics could be combined. For example, device health can be based on a combination of CPU, memory, etc. Network health could be a combination of Wi-Fi/LAN connection health, latency, etc. Application heath could be a combination of response time, page loads, etc. The cloud 120 can generate service health as a combination of CPU, memory, and the load time of the service while processing a user's request. The network health could be based on the number of network path(s), latency, packet loss, etc.

The lightweight connector can also generate similar metrics for the applications. In an embodiment, the metrics can be collected while a user is accessing specific applications that user experience is desired for monitoring. In another embodiment, the metrics can be enriched by triggering synthetic measurements in context of an inline transaction by the application 110 or cloud edge. The metrics can be tagged with metadata (user, time, app, etc.) and sent to the logging and analytics service for aggregation, analysis and reporting.

The synthetic measurements can include probes from the agent application 110, the lightweight connector, etc. The probes can include HTTP/HTTPS probes, network probes, Voice over IP (VoIP) related probes (e.g., Session Initiation Protocol (SIP), Real Time Protocol (RTP), etc.), DNS probes, Proxy probes, etc. The HTTP/HTTPS probes can configure the URL and interval where the probe is run—it is undesirable to have every device running tests. This can include a configured timeout, website authentication (basic, cert, NTLM), HTTP method (POST, GET, etc), SSL, custom headers, and a configured expected HTTP status code, content (string or Regex).

Due to the inline nature and the fact the cloud 120 is an overlay (in-between users and services/applications), the cloud 120 enables the ability to continuously capture user experience metric data and to historically log such data. As such, a network administrator can have a long-term detailed view of the network and associated user experience.

### $5.2 Digital Experience Analyzing

With the various device, application, and network-related metrics, such as in the logging and analytics, it is possible to aggregate these metrics to provide a User Experience (UEX) score. The UEX score can be based on the metrics collected by the application 110, the cloud edge, the cloud 120, the lightweight connectors, etc. The UEX score captures the digital experience and can be based on a given application with associated device, application, and network-related metrics. For example, the UEX score can be determined based on some weighted combination of the device, application, and network-related metrics for a given application and the UEX score can be normalized within a range, e.g., 0 to 100. Again, the given application can be a core business critical application where UEX is important (e.g., Office365, Salesforce, Internal Inventory app, etc.) or any other designated application. The UEX scores can be determined at fixed time epochs (e.g., 15 minute increments, hour increments, etc.) and normalized. Scores can be aggregated for a group of users (e.g. department, location) or for the whole organization. Administrators are provided UEX score reports over time based on user, department, locations, etc. via a Graphical User Interface (GUI). Drilldown reporting capabilities via the GUI allow administrators to identify where there is a problem. For example, administrators can set alerts when a UEX score falls below a threshold. UEX scores for common applications across organizations can be used for peer comparisons and isolating common application issues affecting multiple organizations.

A process for analyzing digital user experience can includes performing inline monitoring of network access between one or more users each with an associated user device executing an agent application, the Internet, and one or more cloud applications and private applications accessible via lightweight connectors; based on user experience metrics collected by the inline monitoring and stored in a logging analysis system, obtaining user experience metrics for one or more users for a given time epoch and for a given application; determining a user experience score for the one or more users for the given time epoch and for the given application based on the obtained user experience metrics; and providing a graphical user interface displaying data related to various user experience scores for various users over various time epochs with various applications.

This process can further include generating and displaying an alert responsive to any user, group of users, location, and organization's user experience score falling below a threshold for a particular time epoch. The process can further include aggregating the user experience for users into groups of users, locations, and organizations, and providing a graphical user interface displaying data related to the groups of users, the locations, and the organizations. The user experience score captures digital experience and is based on a given application with associated device, application, and network-related metrics. The user experience score can be utilized for a specific application for peer comparison, and the process can further include displaying associated user experience scores for the specific application for any users, group of users, locations, and organizations for comparison, and updating the display based on input while a user performs a drill down to remediate poor user experience scores. The process can further include provide additional data including metrics based on input from a user in the graphical user interface.

The various metrics are collected from multiple sources and correlated in the logging and analytics service to come up with a composite UEX score. Again, the sources of the metrics can include application HTTP/S traffic, browser page load times or app specific metrics provide by app vendors APIs/logs; network measurements provided by traceroute tools such as MTR; User Device system metrics (CPU, memory, etc.); cloud tunnel metrics to provide network hops trace between user device and an enforcement node of the cloud 120 (inside tunnel); lightweight tunnels, etc.

Again, the UEX score is determined in the context of a specific application. For example, a computation can include a point system, e.g., 0-10 (10 being the worst). The points can be allocated based on where the user falls within a percentile threshold (e.g., p80), p100 being the worst UEX. Metrics can be weighted, e.g., Latency=4 pts., % CPU=1 pts. For an application and location, calculate average score based on users that are using the application at the location. The overall score is computed based on average UEX score across all users.

### $5.3 Digital Experience GUI

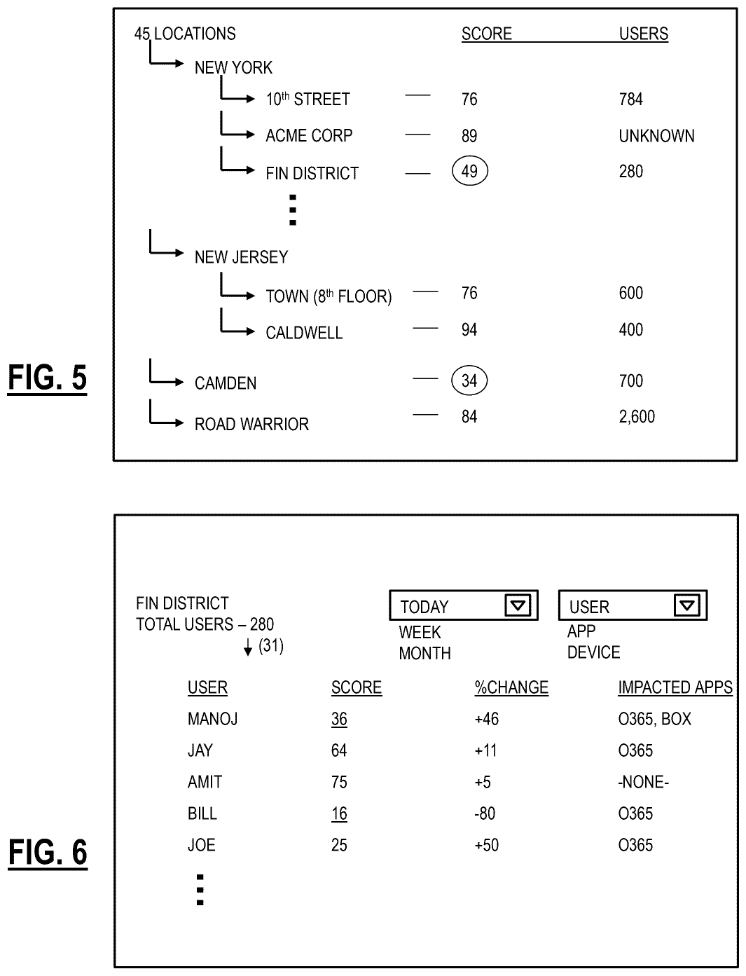

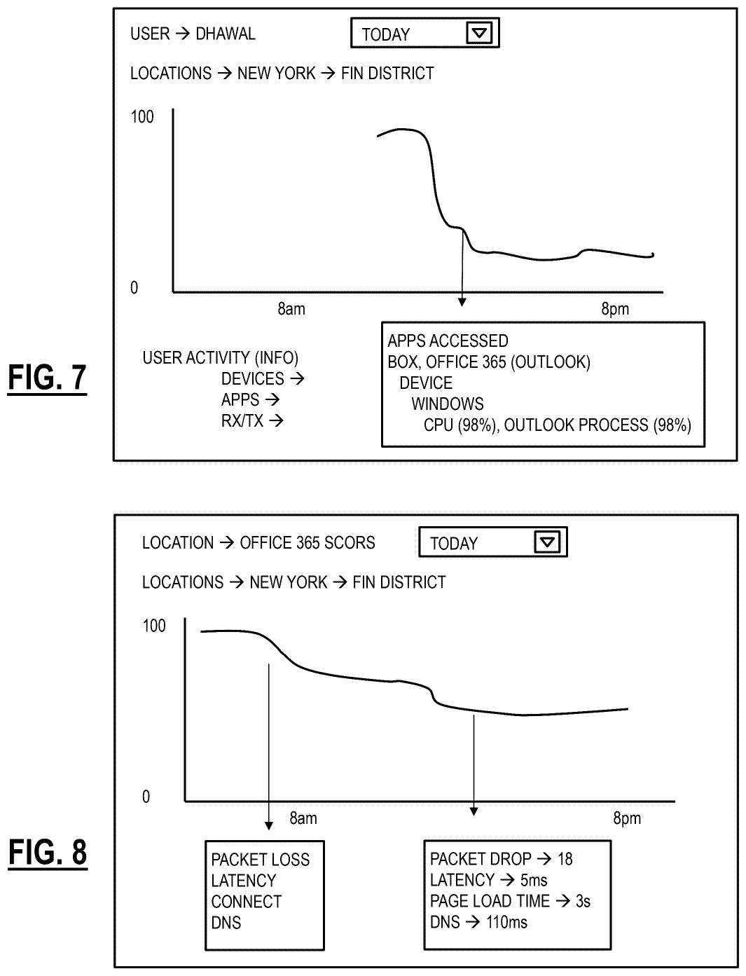

FIGS. 5-18 are various screenshots of a Graphical User Interface (GUI) associated with the analysis service to display, report, and provide a drill down of the User Experience (UEX) scores. FIG. 5 illustrates a GUI listing locations broken down showing an average score of all users at a location. FIG. 6 illustrates a GUI listing a specific location showing users, their UEX scores, a change in UEX score (e.g., over given time epochs), and impacted applications. FIG. 7 illustrates a graph of a specific user's UEX score over time. FIG. 8 illustrates a graph of a specific location's aggregate UEX score over time. Note, a user can drill down on the graph to display data at particular times when the score is low for troubleshooting.

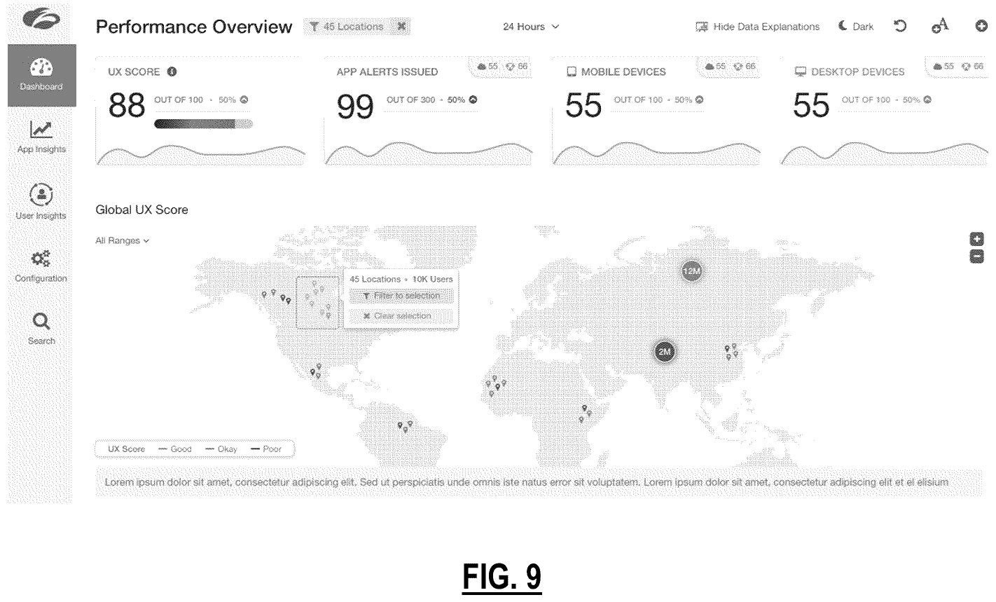

FIG. 9 is a GUI of a global dashboard for the cloud 120. Here, the aggregate UEX score is displayed (all users). There is a listing of application alerts (e.g., threshold crossings), mobile devices, desktop devices, etc. A map displays the global UEX score using color codes for visual indication of locations with good, okay, and poor UEX scores. Again, this visualization can be used for drill down and remediation.

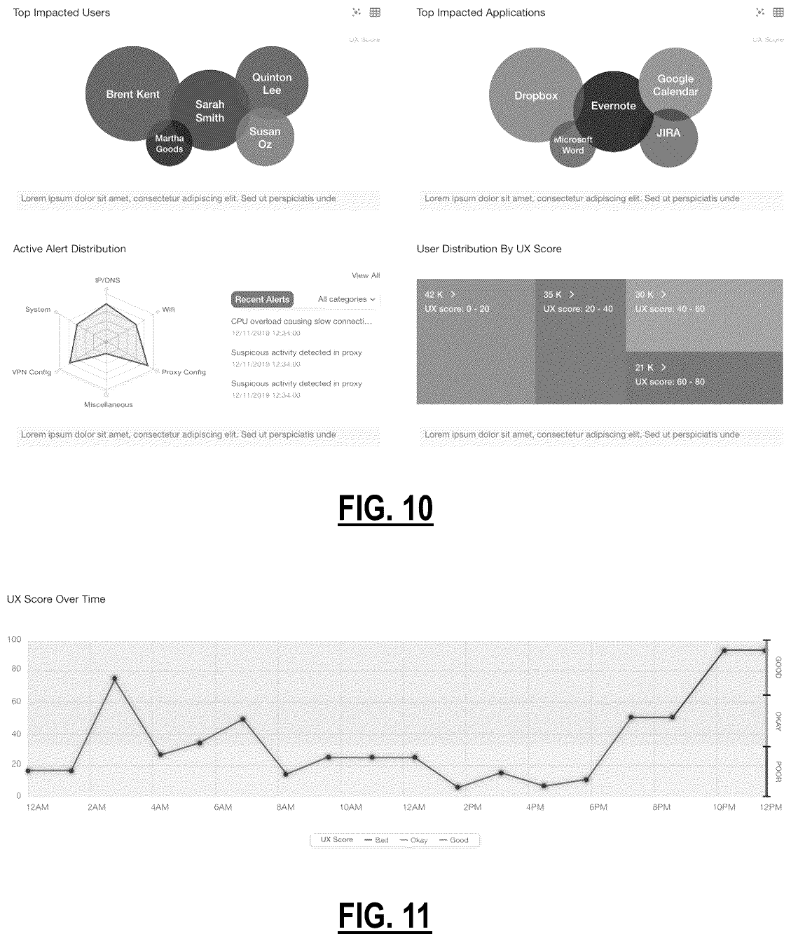

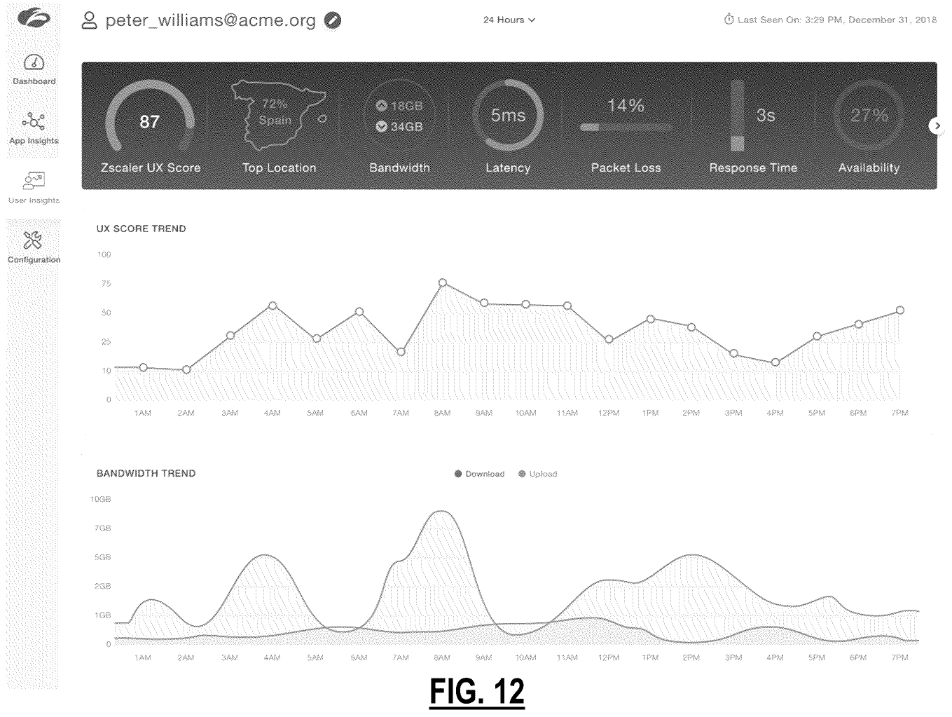

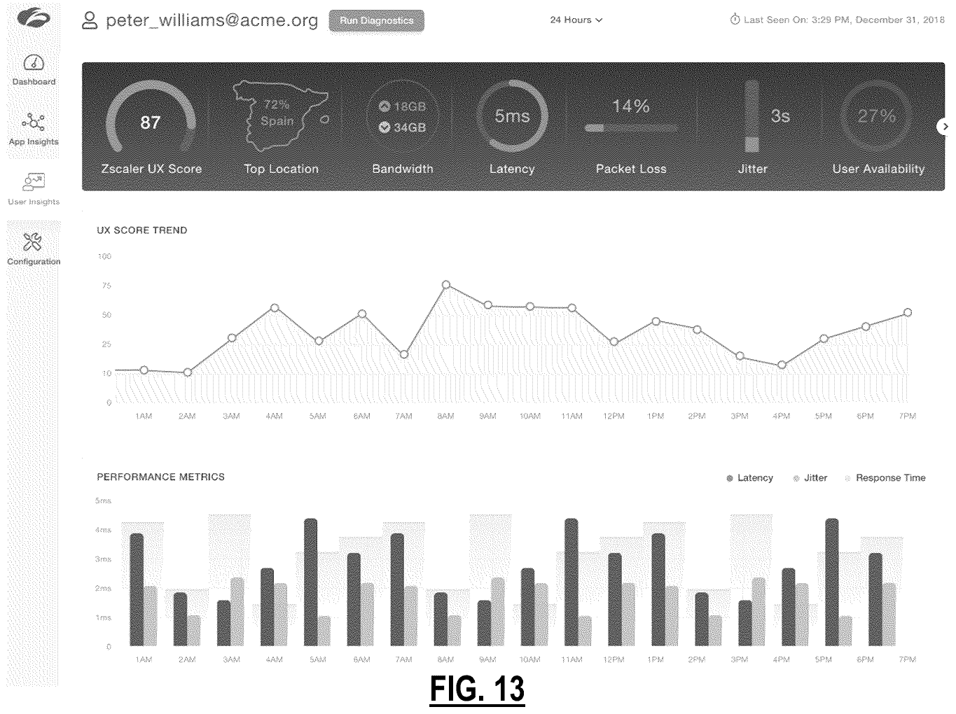

FIG. 10 is a GUI of times in the global dashboard displaying top impacted users, top impacted applications, active alert distribution, and user distribution by UEX score. FIG. 11 is a GUI of a graph of UEX score over time. FIGS. 12 and 13 are a GUI of a dashboard for an individual user. Specifically, the UEX score, location, bandwidth, latency, packet loss, response time, and availability are displayed as are graphs of the UEX score over time and bandwidth for the user in FIG. 12. FIG. 13 includes a graph of various performance metrics over time. Note, the lower performance metrics correlate to lower UEX score.

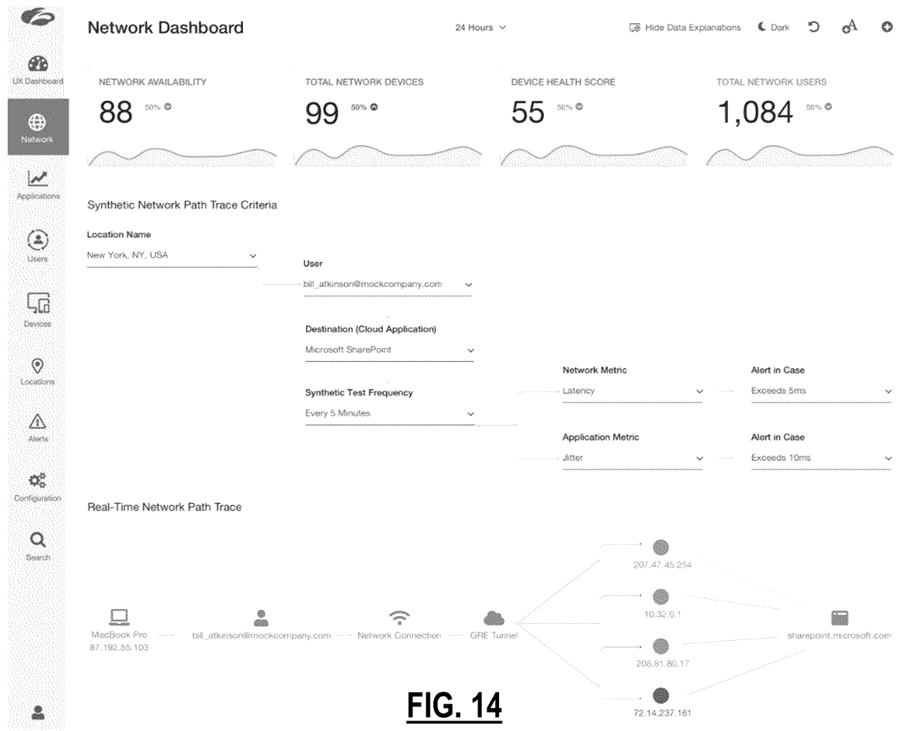

FIG. 14 is a GUI of a network dashboard. This provides a network availability metric similar to the UEX score, a total number of network devices, network device health score which can be similar to the UEX score providing a view of the average network device health, and a total network users. The network dashboard can also include a network path trace criteria which specifies endpoints, destination, users, frequency, metrics, and threshold criteria (“alert in case”). Also, the network dashboard can include a real-time path trace view that illustrates a selected user to a selected application where real-time monitoring occurs which specifies endpoints, destination, users, frequency, metrics, and threshold criteria (“alert in case”). For example, the availability metric can be 100% is GREEN, <100% is RED, Response Time: >5 sec is RED, 3-5 sec is AMBER, <3 sec is GREEN.

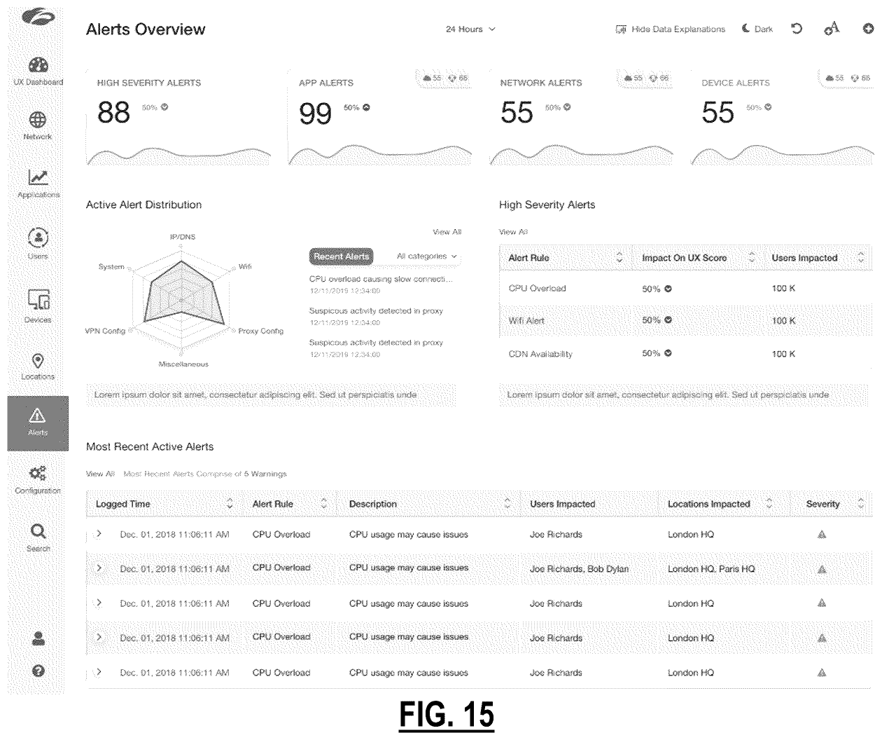

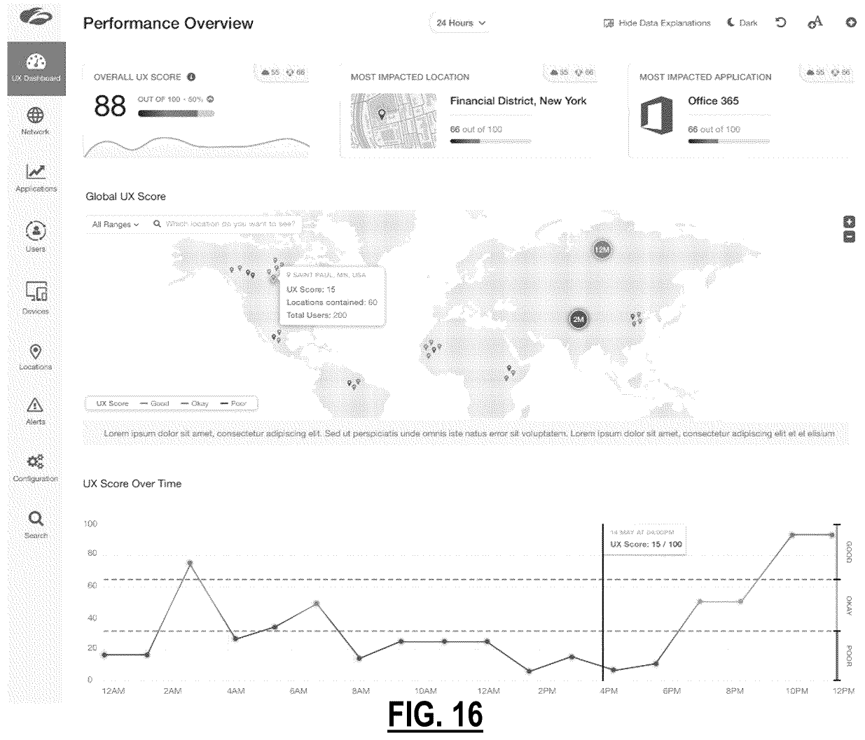

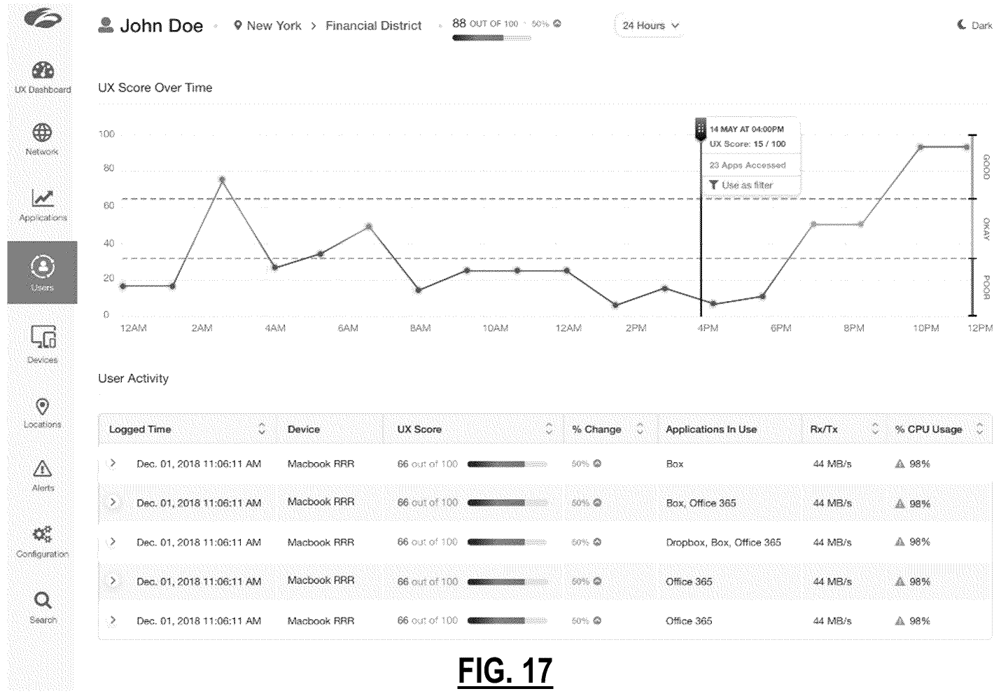

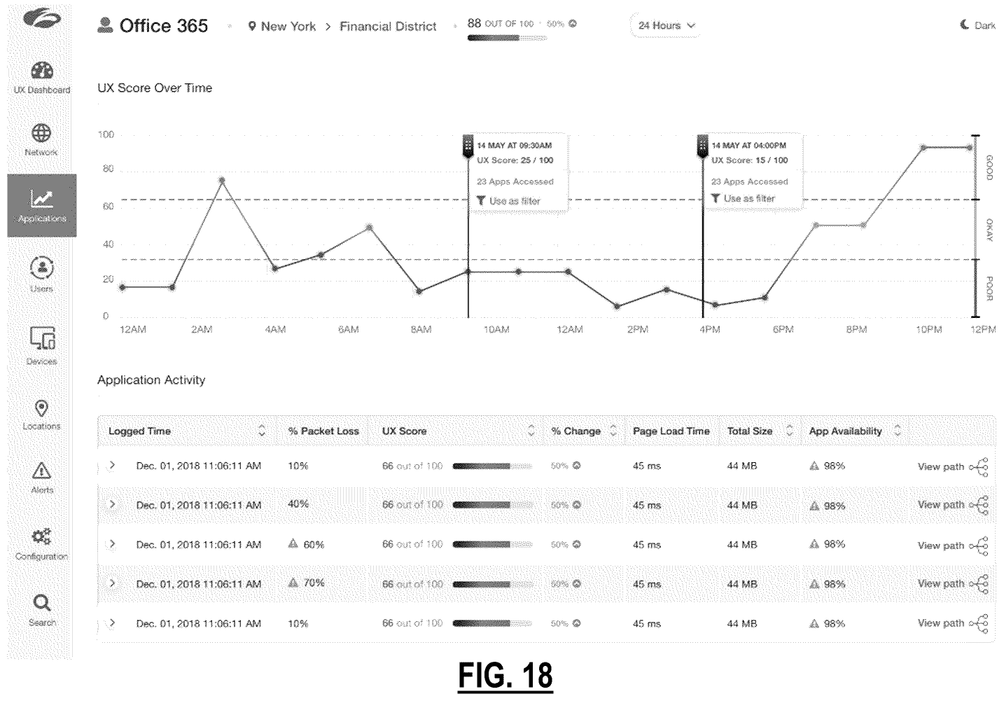

FIG. 15 is a GUI of an alerts dashboard. This includes a number of high severity alerts and a number of application, network, and device alerts. The alerts dashboard further includes a visualization of active alert distribution, a listing of high severity alerts, and a list of the most recent active alerts. FIG. 16 is a GUI of a performance dashboard. This includes the overall UEX score, an indication of the most impacted location and application, a map of global UEX score, and a graph of UEX score over time. FIG. 17 is a GUI of a user dashboard illustrating a single user. FIG. 18 is a GUI of an application dashboard illustrating a single application.

### § 5.4 Improving Digital Experience

With digital user experience monitored and analyzing, it is possible to improve digital user experience in the cloud 120, in real-time. The objective here is to take the monitored metrics and analyzed UEX score and use it for actionable insights that can improve operation of the cloud-based system 100 for the purpose of improving the UEX scores, i.e., remedial actions. Here, an analytics service can operate in conjunction with the monitoring service and the analysis service to provide updates to improve the UEX scores in the cloud 120. For example, these services (the monitoring service, the analysis service, and the analytics service) can operate in the cloud 120 as one or combined services.

The analytics service can include an Artificial Intelligence (AI)/Machine Learning (ML) anomaly detection engine that can isolate common factors affecting the UEX score. For example, Wi-Fi network coverage could be poor in a location, DNS resolution could be taking too long, there could be network congestion between two Internet Service Provider (ISP) peering points, authentication for an application could be taking an abnormally long time, etc. With the logging and analytics, it is possible to review historical data to train the AI/ML anomaly detection engine for ongoing detection.

The analytics service can provide policy based actions to be taken based on the UEX score by the cloud service and/or the organization's IT. For integration with the organization's IT, examples include i) if UEX score falls below threshold, open service ticket with detailed metrics and reports captured, ii) enable granular analysis with packet captures on application 110 based on certain conditions, iii) change tunnel from office to different cloud service providers to improve network path, iv) enable bandwidth controls to provide QoS for a business critical application, etc. Example actions that could be taken by the cloud service include auto scale cloud service resources to improve a performance bottleneck, use the cloud edge to choose better network path, etc.

### 86.0 Alerts for Monitoring and Responding to Specific Events

Again, the cloud 120 has the ability to monitor, diagnose, generate alerts, and perform remedial actions with respect to network endpoints, network components, network links, etc. The alerts generated can be with regard to any aspect of the inline monitoring disclosed herein and can be based on rules establishing specific criteria and conditions that, when fulfilled, trigger the alert(s).

Alerts can be triggered when results meet a specific condition defined by an alert rule. An alert can also have an action, such as a notification of the alert, associated therewith, such that when alerts are triggered, the action is also triggered. For example, an email can be sent, webhooks can be triggered, or messages can be sent via 3rd party integrations such as Servicenow, Pagerduty, Slack, etc.

Actions can be triggered when the alert becomes active, i.e. only at the start, and can also be triggered once the alert is cleared. Further, when multiple alerts are active simultaneously, the data can be grouped into a single action/notification (such as an email) to reduce noise in the system. Alerts and actions triggered therefrom can be customizable by the user.

Any combination of rules can be established relative to the inline monitoring and the data and metrics collected therewith. For example, the rules can include one or more of the following: (1) when a UX score degrades by certain threshold percentage over a predetermined or selected period of time; and (2) any of the metrics of the inline monitoring meets a predetermined or selected threshold for the respective metric, such as a UX score, network latency (per log), percentage of packet loss (per leg), total hop count, per leg hop count, incomplete traceroutes, DNS time, Page Fetch Time, availability (HTTP errors), and device health metrics. More particularly, the rules can trigger an alert if: the overall UX score in any location is less than 70% in the past 24 hours; if there are more than 5% or 100 devices seeing a 500 error for web monitors; a particular device has not sent any data for a predetermined or selected amount of time (e.g. in the last 4 hours); a traceroute probe did not complete; a user has a predetermined or selected number of failed web monitor requests within predetermined or selected period of time, for example, 3 failed web monitor requests in 10 minutes (alerts can be throttled so that it triggers only once in an hour for failed logins from the same user); a web application has more than a predetermined or selected number of errors and/or a page fetch time greater than a predetermined or selected time more than a predetermined or selected number of times in a row; a UX score in a specific location becomes below average for that region; and a UX score within a setup geofence degrades from good to okay, such as below 66%.

Triggering events based on the alert rules can be checked in real time or can be checked on a predetermined or selected interval, for example, every five minutes. The predetermined or selected interval can be aligned and synchronized with the monitors/inline monitoring described above. In order to reduce noise by sending multiple notifications for the same or similar alerts, alert criteria can be included to limit the notifications. For example, alerts can be limited to when the alert event occurs a predetermined or selected number of times in a row, if the alert events impact a predetermined or selected number or percentage of devices in a particular location, group, department, operating system version, and the like. Furthermore, a repeating alert event can be throttled so that only one notification of the alert is sent or the alert is only triggered once. For example, if the same alert event starts/stops multiple times within 1 minute, the alert can be throttled to send only one notification.

Again, as shown in FIG. 15, an alerts dashboard can include a number of high severity alerts and a number of application, network, device alerts, a visualization of active alert distribution, a listing of high severity alerts, and a listing of the most recent active alerts, which can be available under an alerts tab.

The severity level can be selected from a plurality of severities, which can be predetermined, defined by an administrator, and the like. The severity level can be selectable from a drop down menu. For example, severity levels can be identified as: high, where a critical incident with outage impact occurs, such as when a key application is down for all users; medium, where a critical incident with significant impact occurs, such as when a key application is not accessible for a subset of users; and low, where a minor inconvenience to users occurs, such as when usable performance degradation occurs.

The alert rule can further be configured by selecting which metrics, such as: a ZDX Score; web (fetch time, DNS time, error etc.); traceroute (latency, percent loss, number of hops, incomplete trace route); device health (CPU, memory, etc.); any other criteria disclosed herein, and the like. The threshold or conditions of those metrics that will trigger the alert can also be set. These conditions can be set where any condition met will trigger the alert or where all of the conditions need to be met to trigger the alert. The alert criteria can include percentages, durations, number of times in a row that the condition occurs, etc. An operator can indicate whether the criteria that occurs is less than (<), greater than (>), equal to (=), less than or equal to (≤), greater than or equal to (≥), an error message (!=), and the like. For example, for web monitor, HTTP Code>=500, for a traceroute, percent loss≥1%, for a SharePoint, score<50%, and for a device percent, CPU>80% 10 times in a row. This can be accomplished via a criteria screen of the GUI.

The determination of when an alert is raised can be based on baselined data. For example, one vendor can compare the metric value to a weighted average of all historical metric data and if the value is greater than the average value by a predetermined or selected value of standard deviations, then the alert is raised.

The action taken when the alert is triggered can also be configured. This can include selecting a throttling value for a number of times the event needs to occur in a row, how many devices are impacted based on either a number or percentage of devices, and the type of notification that is sent, such as email, Webhook, etc. This can be accomplished via an action screen of the GUI.

Referring again to FIG. 15, the GUI can display a list of alerts that occurred within a predetermined or selected timeframe, such as 24 hours, 48 hours, 3 days, 7 days, 30 days, etc. The alerts displayed can be filtered by a global filter, by application, location, geo location, user(s), device type, operating system, operating system version, and the like. The alert display can include a chart that shows UX scores and numbers of alerts. The list view can also be filtered by clicking on or selecting the alerts number.

The list view can include a number of columns providing information with regards to each alert. The list view can include columns for alert identification, an alert name, an alert status (active, cleared, disabled, muted), an alert start time, an alert duration (no end time if alert still active), a monitor name (source of the alert), metrics values that caused the alert to trigger, action taken (email) with a link to the Alert action, impacted geo locations with a score, impacted locations with a score, impacted applications with score, number of impacted users (with link to users), impacted groups, impact departments, impacted device types, and the like.

The list view of the alerts can be configured to auto refresh on a predetermined or selected time interval, such as once a minute. The list view can also be sorted based on the columns, and administrators can disable, suppress, and clear a single alerts or multiple alerts in a single action.

Identifiers, such as color coding can be included in the list view of alerts to quickly identify certain aspects of the alerts, such as if the alerts are active, cleared, muted, disabled, and enabled. For example, an active alert can be shown as red for high severity and orange for a warning severity, a cleared alert can be shown as green, a muted alert can be shown as blue, and a disabled alert can be shown as gray.

An alert detail page can be reached, for example, by selecting a link from a notification or by selecting the alert from the list view of alerts. The alerts detail page can include a map illustrating the impacted geolocations along with a number of events that occurred at that location, which can be an overlay on the map. The alerts detail page can also include a list view of the locations (such as defined fences) with the number of users impacted and can include a list view of the users impacted. The list view of the users impacted can include columns for a user identification, the device, the department, the location, the geolocation, the operating system, the operating system version, and the like.

The alert detail page can also list the departments, geolocations, and locations impacted with a number of events that occurred for each department, geolocation, and location. The alert detail page can further list the rules (expression triggers) that define the events that trigger the alert.

Again, alert actions can include sending email notifications to one user or a list of users, sending one or more webhooks, and sending one or more notifications via third party integration, such as by sending alert data to an external event, incident management or operations center system such as ServiceNow, Slack, PagerDuty, and the like.

Email notifications can rely on email configurations of the cloud 120, and thus, may not require configuration of the email server and authentication within the GUI for configuration of the alerts. Establishing an alert for email notifications can simply require the one or more email addresses that the alert will be sent to.

### § 7.0 Observability Metrics Pipeline

An observability metrics pipeline, or telemetry data pipeline, is a centralized system for aggregating data from a plurality of sources, performing transformation and enrichment processes, and directing data to a plurality of diverse destinations. Implementing such a pipeline solves issues related to dispersing data by consolidating it to a unified location. The system further aids in organizing and enhancing data for improved comprehension and value extraction. Further, use of such a pipeline enables the distribution of data to a plurality of destinations and teams to cater to various use cases as well ensuring that only relevant data is sent to the appropriate destination in the correct format.

Current monitoring systems operate on a simplistic threshold-based alerting mechanism, which triggers alerts whenever individual metrics such as CPU usage, disk space, or memory consumption exceed predetermined thresholds. These methods, while straightforward, lack the necessary context to accurately reflect the overall health of the system. For example, a breach in the CPU usage threshold might not necessarily indicate a critical system issue if other metrics, like memory usage and disk I/O, remain within normal ranges and the system continues to function optimally.

The primary issue with relying on single-metric alerts is their tendency to highlight temporary fluctuations rather than sustained or significant problems. These transient spikes can cause false alarms, leading to unnecessary investigations and potentially diverting attention from genuine issues. As a result, IT teams may experience alert fatigue, where the constant stream of alerts diminishes their effectiveness and response times.

To overcome these limitations, a more sophisticated approach involves correlating multiple metrics to form a holistic view of the system's performance. By analyzing the interrelationships between various system parameters to gain a complete understanding of the state of a system, network, device, etc., it becomes possible to establish a more accurate understanding of the system's true status. The present methods involve setting up complex event processing rules that consider the behavior of multiple metrics simultaneously. For instance, a combination of high CPU usage, increased memory consumption, and elevated disk I/O might collectively indicate a performance bottleneck that wouldn't be apparent from any single metric alone.

Implementing a correlation-driven strategy ensures that alerts are generated only when a collective set of metrics deviates from the expected norm. This approach provides a more comprehensive and meaningful assessment of the system's health and performance. It reduces false positives and ensures that alerts are more indicative of actual issues that require attention. Consequently, IT teams can focus their efforts on resolving real problems, improving system reliability, and maintaining optimal performance. This advanced monitoring capability not only enhances operational efficiency but also contributes to better resource allocation and improved user satisfaction.

The present observability metrics pipeline is adapted to enhance the monitoring and understanding of complex systems such as customer cloud environments by following a unified and streamlined process for handling data. The observability metrics pipeline process includes comprehensive data aggregation, transformation and enrichment, efficient issue resolution, enhanced decision making, adaptability to diverse use cases, and resource optimization.

Comprehensive data aggregation includes collecting data from a plurality of sources such as applications, infrastructure, and user interactions through cloud connectors and putting such data into a centralized repository. In various embodiments, the data and repository can be tenant-based, meaning that each tenant/customer of the cloud 120 can have their own repository that reflects their network and devices for data security. This ensures a holistic view of the tenants entire system performance and behavior.

Transformation and enrichment include processing the raw data to structure and enrich it, making it more meaningful and easier to interpret. Further, context and additional information can be added to aid in analysis and troubleshooting.

Issue resolution includes quick identification and resolution of issues by providing real-time insights into system anomalies and deviations. Proactive monitoring can further facilitate the prevention of potential problems before they impact operations.

Enhanced decision making includes empowering teams with valuable organized data to make informed decisions and optimize system performance. This further supports data-driven decision making by providing actionable insights.

Because diverse use cases can present themselves, the present systems cater to the specific needs of different teams and use cases by allowing flexible routing of data to various destinations. A diverse range of observability tools and platforms for analytics, alerting, and reporting can also be supported.

To facilitate resource optimization, the systems can control the volume of data to avoid unnecessary resource consumption. This includes sending only relevant data to the right destination, thus reducing the risk of information overload.

Based thereon, the present observability metrics pipeline serves as a vital component for ensuring that tenants can effectively manage and monitor their systems/networks.

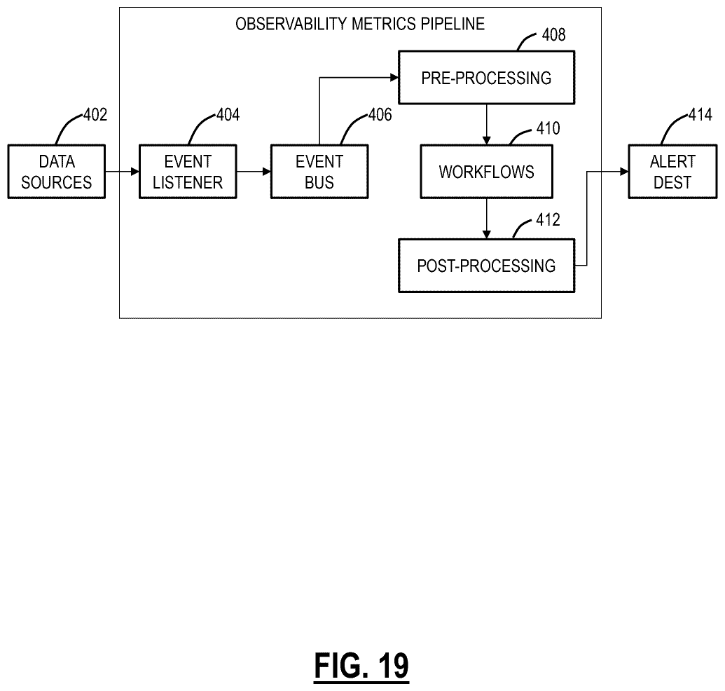

FIG. 19 is a flow diagram of the present Observability Metrics Pipeline (OMP) architecture. The workflow represented in FIG. 19 shows how data is ingested, analyzed, and provided to various destinations. In various embodiments, the OMP platform includes various event listeners 404 that are adapted to ingest events from a plurality of data sources 402. Events can be contemplated as any anomalies that occur within an organization's network/environment. The data sources 402 can include any alerting service/source such as, but not limited to, Grafana, Git, ArgoCD, Alertmanager, Lamda, AWS SNS, AWS Cloudwatch, and the like. an event bus 406 is employed to create a queue for incoming messages from different sources, effectively separating the event listener 404 from the process executors/sensors. This design ensures a non-blocking call throughout the entire flow. A pre-processing layer 408 facilitates the transformation of data from diverse sources into a standardized format, serving as input for data processing workflows. The workflow layer 410 meticulously structures and enriches the incoming data, strategically assessing alerts and making informed decisions before promptly notifying end users. The post-processing layer 412 plays a crucial role in adapting the data generated by the workflow layer 410 to meet the requirements of various alerting and database systems such as, but not limited to, Slack, SQL databases, PagerDuty, etc. The post-processing layer includes services for notification, database, and remedial actions. These microservices expose diverse endpoints which offer notification services to different systems using the data supplied by the post-processing layer 412. The notification service pre-configures various notifications endpoints and groups them under different tags. The application consuming the notification service only needs to be aware of the tags and can choose the tag to notify the group of endpoint services. This helps in decoupling the notification endpoint services and the alert processors. The alert destinations 414 can include various applications and databases. All the alert data being processed can be published to a database as a part of the notification. This data can be used to generate reports such as to analyze the number of alerts received, number of critical alerts received, and groups of different alert types. An alert database is used to store all alert metrics data into a common alerting database to generate reports and display findings in dashboards such as the various GUIs described herein.

### § 8.0 Intelligent Incident Management, RCA, and Automated Remediation

The present disclosure relates to intelligent incident management, Root Cause Analysis (RCA), and automated remediation using Artificial Intelligence (AI)-driven predictive analytics. In a large distributed system such as the cloud 120, data flow across data planes is managed by multiple components, virtual machines (VMs), and networks. Any issues within these components or networks can significantly impact customer data traffic, making it challenging to track and troubleshoot problems in a distributed architecture spanning multiple regions. Delays in identifying the root cause of an issue can lead to extended resolution times, resulting in customer outages and breaches of Service Level Agreement (SLA) metrics. Therefore, it is crucial to swiftly pinpoint the root cause to ensure prompt resolution. Current systems require engineers to navigate various metrics dashboards, log analytics, and sometimes directly access VMs, switches, routers, and other network elements. This complexity is exacerbated when the system is distributed across data centers (DCs) and regions, necessitating the use of different tools. RCA heavily relies on administrators' ability to correlate diverse metrics, logs, and configurations across multiple systems. This manual process is prone to human error and delays in deriving RCA. Additionally, administrators often depend on their previous knowledge or documentation to locate the appropriate remediation scripts and steps to resolve the identified issue.

The present solution described herein revolutionizes issue resolution by harnessing the power of AI-driven predictive analytics. The present processes anticipate and identify the root cause of an incident, streamlining the troubleshooting process. This approach meticulously analyzes the comprehensive data available to the cloud 120 associated with applications and logs gathered during the precise timeframe of issues, providing invaluable insights to swiftly pinpoint and address underlying issues. This proactive methodology not only expedites problem resolution but also minimizes downtime, ensuring optimal performance and adherence to service level agreements (SLAs).

In various embodiments, the present systems are adapted to automatically generate comprehensive RCA for any alerted issue by leveraging AI-driven predictive analytics. By analyzing data gathered during critical time frames of issues, the systems can pinpoint underlying causes with great accuracy. Such an approach allows the present systems to identify root causes quickly, facilitate targeted resolution, and minimize downtime. Further, the present systems are adapted to, based on the automated RCA, select a most appropriate remediation script from a curated library, tailored to address the specific RCA generated for the alerted issue. The present automated remediation process ensures that a correct and optimized solution is quickly applied to resolve the issue effectively. Additionally, the present systems can leverage AI to analyze production data and dynamically adjust alerting thresholds for various metrics. This ensures that alerts are triggered only when truly necessary. Such an approach eliminates false positives, minimizes noise, and maximizes the effectiveness of tenant monitoring configurations. each

As described, the present systems for automated RCA and remediation are an integral part of the OMP platform described herein. As explained, the present systems empower automatic RCA that is generated by leveraging a combination of application metrics, graphs, and historic logs. This approach enables the generation of actionable RCAs for issues that have been identified and verified by the present systems. In order to achieve this, various embodiments include training and fine tuning multi modal Large Language Models (LLMs) with a comprehensive dataset including all received metrics and log data from cloud connectors. Whenever an alert is triggered by the OMP, the trained LLM is queried to provide a detailed RCA based on the applications metrics and graphs over a past time period. That is, the OMP is adapted to feed the LLM graphs and other metrics, which the LLM is adapted to interpret to determine an RCA of an event. For example, the OMP can feed the LLM a graph showing CPU usage over a period of time in addition to a plurality of other graphs and metrics. Based thereon, the LLM is adapted to analyze the graphs and metrics, and determine a cause of an issue. That is, the LLM may determine that the CPU usage has increased over the period of time and identify that as the cause based on the other graphs and metrics. Alternatively, by leveraging other metrics and graphs, the system may determine that the CPU spike is not indicative of an alert, and is simply a routine spike that is not an issue. The LLM described herein is adapted to learn particular states of environments, devices, etc. based on metrics and graphs in order to determine when an actual issue is occurring. By doing so, the present systems do not rely on singular thresholds for issuing alerts and alternatively learn states of networks, devices, applications, etc. based on a plurality of metrics and graphs to determine an issue based on combinations of data.

In various embodiments, a plurality of LLMs can be utilized, each specialized for different tasks. For example, one LLM can be adapted to verify alerts, another can be adapted to perform automated RCA, another can be adapted to perform automated remediation, while another can be adapted to perform automated threshold modifications.

Alternatively, in various embodiments, a single trained LLM can be utilized to perform the verification of alerts, automated RCA, automated remediation, and perform automated threshold modifications. The utilization of a single model helps the LLM to be context aware of every detail. For example, for deriving on a remediation for an Issue it would help the LLM to know the RCA and related metrics.

The LLMs can be trained to associate specific remediation procedures and scripts with distinct issues. This allows the LLM to recommend tailored solutions for quick resolution. For example, when a high disk space consumption alert is received, the LLM can be trained to find and utilize a script built for cleaning disk space. To ensure that the system can effectively diagnose and resolve a wide range of issues with precision and accuracy, different scripts are linked to various issues to refine the LLMs performance.

In an example use case, consider a scenario where frequent outages are occurring in the cloud 120 cloud connector data network. When the OMP receives a verified alert, it is adapted to send relevant metrics and graphs. These metrics and graphs for this specific issue can include CPU usage, memory allocation, disk space consumption, input/output packets, availability metrics, log metrics (warnings, errors, etc.), and the like. The LLM then analyzes these metrics and graphs, associating trends and patterns to predict the root cause of the outage. For example, if high input/output and CPU usage are found to be consistently increasing, accompanied by packet drops over a specific period, the LLM will identify this trend and provide an RCA with actionable insights (remediation steps). The suggested remediation script can include steps such as optimizing system resources or adjusting network configurations to mitigate the issue. By utilizing and combining advanced analytics and machine learning capabilities, the present system is able to provide insight into complex issues, enabling immediate resolution and minimizing downtime for critical cloud-based services such as those described herein.

In various embodiments, the present Artificial Intelligence (AI) system is adapted to, over time, learn optimal thresholds to be configured for each received metric. The OMP system can periodically query the AI system for optimal thresholds to be set for each metric and automatically reset the thresholds. Based thereon, responsive to critical thresholds being breached, the OMP platform can be initiated to collect relevant metrics and graphs for the time period, for example the past 12 hours, and send them to the multi modal LLM for thorough analysis. The LLM, trained on a vast dataset of graph data and remediation procedures, leverages its advanced language processing capabilities to generate an RCA for the alerted issue. In various embodiments, this comprehensive RCA includes a recommended remediation script, empowering the system to quickly identify and resolve issues.

In one use case, consider a CPU usage alert. Most metrics are not inherently bad even with a threshold. The CPU usage being abnormally high is not necessarily an indicator of an issue, depending on other metrics (i.e., throughput is also high at the time of high CPU). Some metrics that are generally related and help determine the validity and extent of a possible issue include CPU usage, memory usage, throughput, etc. the following example can demonstrate how the present systems determine the validity of a CPU alert. Responsive to a high CPU usage alert, the systems can retrieve a memory usage value. If the memory usage value is low, the systems can determine that this is unnatural, and send a verified alert. If the memory usage value is high, more data might be necessary to verify the alert. This demonstrates how the present models can leverage combinations of data in order to identify and verify alerts. Traditional methods include utilizing single data points to make such determinations, resulting in high numbers of false positives.

### § 8.1 Auto Root Cause Analysis (RCA) and Remediation Training

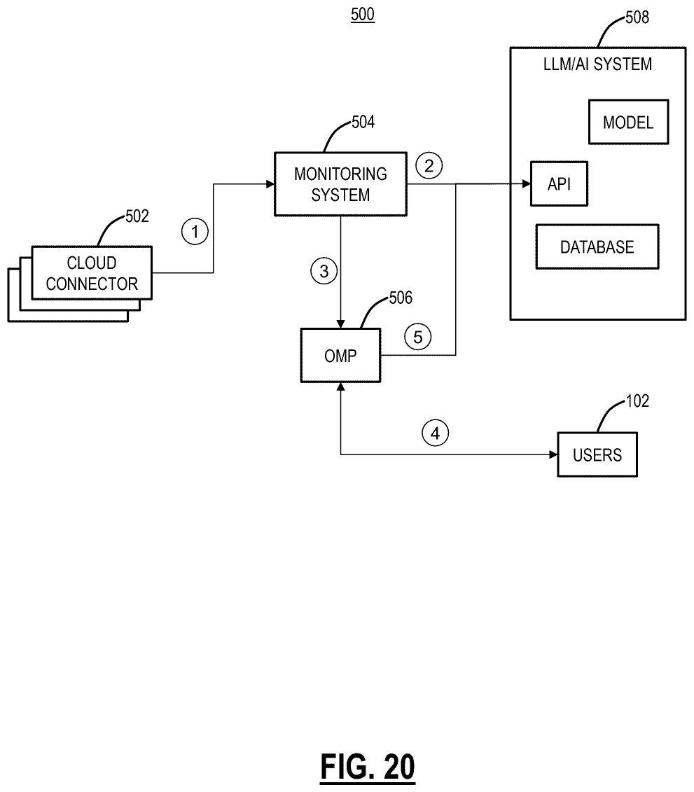

FIG. 20 is a flow diagram of a process 500 for training a model to perform automated RCA. In the first step of FIG. 20, a cloud connector 502 regularly (for example, every minute) send system metrics (hardware, software metrics and logs) to the monitoring system 504 for each cloud connector 502. In the second step, these metrics are periodically sent to the AI system 508, i.e., the LLM, for learning. In a third step, the monitoring system 504 generates alerts for any given metric depending on the thresholds configured for the metric. These alerts are sent to the Observability Metrics Pipeline (OMP) 506 for further processing. Again, the OMP 506 is a workflow platform which does further processing on the alert received and correlates the different metrics data for the cloud connector 502 for the alerting period. In a fourth step, the OMP 506 sends the alerts to admins/users 102 through the alerting channels. Once the users 102 are able to diagnose the issue and generate the alerts, these alerts are fed back into the OMP 506. Finally, in a fifth step, the OMP 506, on receiving the manual RCA generated by the users 102, feeds this data into the AI system 508 for further learning.

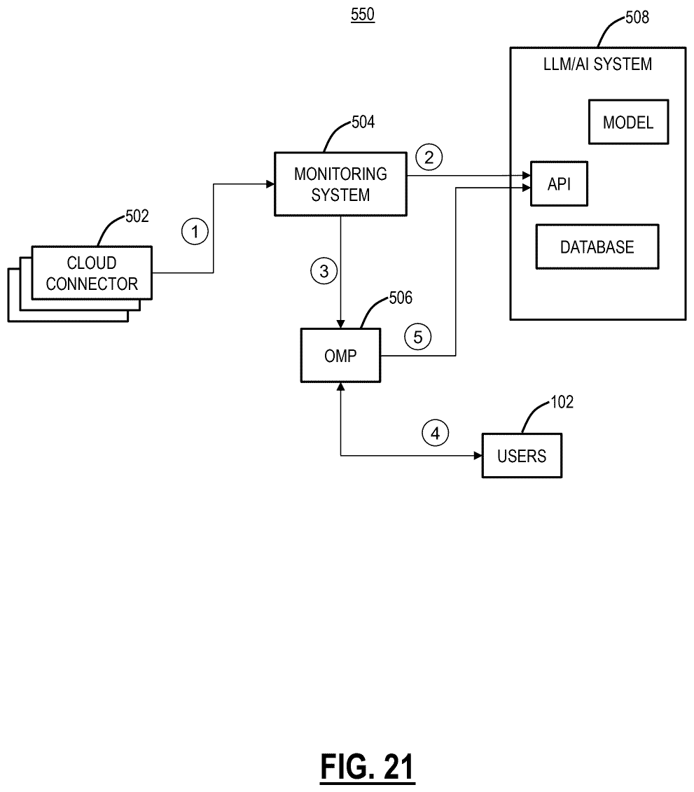

FIG. 21 is a flow diagram of a process 550 for training a model to perform automated remediation. In a first step of process 550, a cloud connector 502 regularly (every minute) sends system metrics (hardware, software metrics and logs) to the monitoring system 504 for each cloud connector. Again, a cloud connector 502 can be contemplated as an on premises component that is adapted to forward all traffic from a network to the cloud 120 to allow the cloud 120 to perform the various actions described herein. In various embodiments, each tenant of the cloud 120 can be associated with one or more cloud connectors 502. The cloud connector can be contemplated as an on premises device and/or the application 110. In a second step of process 550, the metrics are periodically sent to the AI system 508 for learning. In a third step of process 550, the monitoring system 504 generates alerts for any given metric depending on the thresholds configured for the metric. These alerts are sent to the OMP 506 for further processing. Again, the OMP 506 is a workflow platform which does further processing on the alert received and correlates the different metrics data for the cloud connector for the alerting period. Once the OMP 506 receives the RCA for the current alert the RCA is sent to a user/administrator 102 associated with the tenant or the cloud 120. In various embodiments, a manual process is contemplated where the user/administrator 102 creates a series of steps to resolve the issue. Based thereon, in a fourth step of process 550, these remediation steps are pushed to OMP 506 along with the alert ID. In a fifth step of process 550, responsive to the OMP 506 receiving the manual remediation steps from the user 102, the OMP 506 feeds this data into the AI system 508 for further learning. The OMP 506 continuously sends all the manual and auto remediation steps taken for any alert into the AI system for further learning.

As described, the cloud 120 is a multi-tenant service that receives data from a large number of users, each associated with specific tenants. Based thereon, the various models described herein can be specifically trained and fine tuned for specific tenants. That is, a tenant is one of a plurality of tenants of the cloud system, and the one or more LLMs described herein can be trained based on tenant-specific metrics, graphs, and historic logs. Thus, the tenant-specific models can be better suited for identifying issues, performing RCA, and remediating for each tenant of the cloud 120. Further, tenant data is not shared between models of different tenants of the cloud 120.

### § 8.2 Auto Root Cause Analysis (RCA) and Remediation

As described, the present systems are adapted to automatically generate comprehensive RCA for any alerted application issue by leveraging AI-driven predictive analytics. By analyzing data gathered during critical time frames of issues, the systems can pinpoint underlying causes with great accuracy. Such an approach allows the present systems to identify root causes quickly, facilitate targeted resolution, and minimize downtime. Further, the present systems are adapted to, based on the automated RCA, select a most appropriate remediation script from a curated library, tailored to address the specific RCA generated for the alerted application issue.

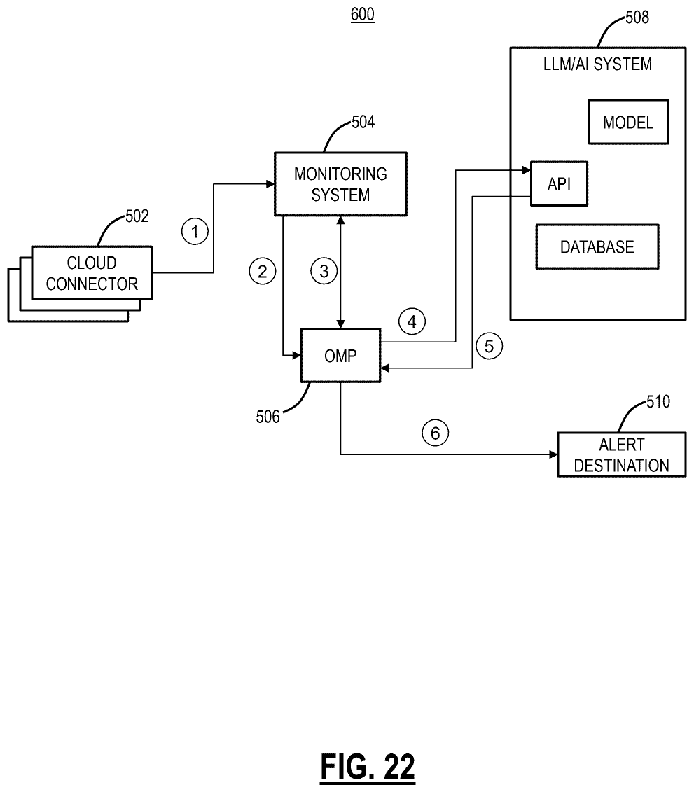

FIG. 22 is a flow diagram of a process 600 for generating automated RCAs. In a first step of process 600, the cloud connector 502 regularly (every minute) sends system metrics (hardware, software metrics and logs) to the monitoring system 504 for each cloud connector 502. In a second step of process 600, the monitoring system 504 generates alerts for any given metric depending on the thresholds configured for the metric. These alerts are sent to the OMP 506 for further processing. In a third step of process 600, the OMP 506 fetches the graphs for a specific time period (for example, 6 to 12 hrs.) of different metrics for the alerting cloud connector 502 from the monitoring system 504. In a fourth step of process 600, the OMP 506 sends the graphs and requests for providing an RCA from the AI system 508. In a fifth step of process 600, the AI system 508 is able to generate the RCA for a given cloud connector 502 with the periodic info received by it and the point in time graphs provided to it. As described, the system will be able to correlate the different metrics and logs to provide the RCA. In a sixth step of process 600, the OMP is adapted to send the alert to a messaging application such as Slack or any other destination application 510 of the like.

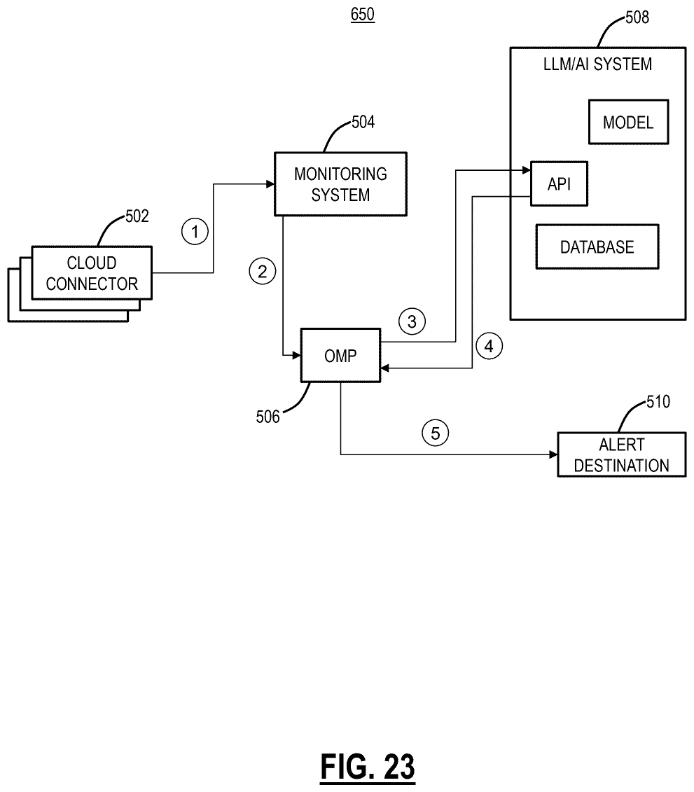

FIG. 23 is a flow diagram of a process 650 for performing and generating automated remediation. In a first step of process 650, a cloud connector 502 regularly (every minute) sends system metrics (hardware, software metrics and logs) to the monitoring system 504 for each cloud connector 502. In a second step of process 650, the monitoring system 504 generates alerts for any given metric depending on the thresholds configured for the metric. These alerts are sent to the OMP 506 for further processing. In a third step of the process 650, the OMP 506 uses the generated RCA (from process 600) and queries the AI system 508 for the remediation steps with the RCA received for the alert. In a fourth step of process 650, the AI system 508 generates the remediation steps for the given RCA. In a fifth step of process 650, the remediation steps are sent to Slack, or any other destination application 510, for alerting.

As described herein, the present systems are further adapted to, over time, learn optimal thresholds to be configured for each received metric. The OMP 506 can periodically query the AI system 508 for optimal thresholds to be set for each metric and automatically reset the thresholds. Based thereon, responsive to critical thresholds being breached, the OMP 506 can be initiated to collect relevant metrics and graphs for the time period. Traditionally, all components of such systems rely on manual configuration of metric thresholds decided by administrators with their previous insights into application monitoring metrics. These thresholds are not regularly updated or improved, leading to false positive alerts. By implementing the automatic and dynamic threshold update processes described herein, the present system can be much more accurate in determining alert worthy issues.

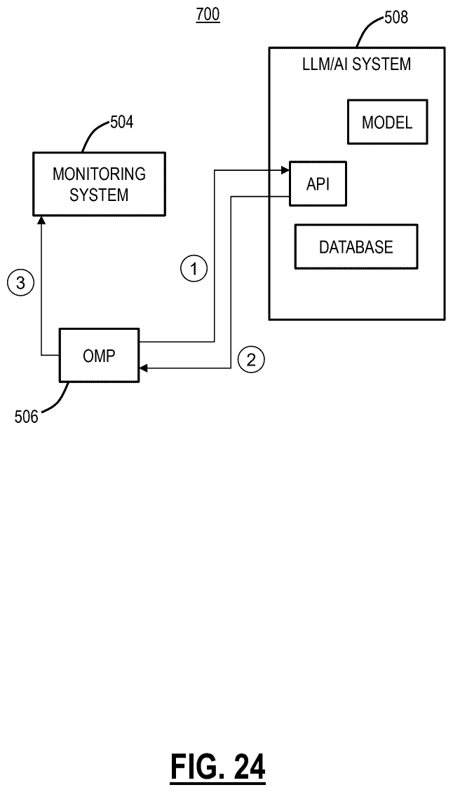

FIG. 24 is a flow diagram of a process 700 for automated threshold configuration. In a first step of process 700, the OMP 506 periodically (scheduled intervals) queries the AI system 508 to get the optimal threshold for every metric. The AI system 508 learns from the past alerts and the system metrics received regularly to generate such thresholds. In a second step of the process 700, the AI system 508 provides the best threshold that can be configured for the given metric. In a third step of the process 700, the OMP 506 compares the given metric threshold with the current threshold. If there is a change in the threshold, the OMP 506 reconfigures the monitoring system with the new metric threshold.

It will be appreciated that each of these processes can be facilitated by individually trained LLMs. That is, the present systems can utilize a plurality of LLMs to perform the tasks outlined herein.

The main advantage of this invention is its ability to simplify and speed up the troubleshooting process. By utilizing AI-powered predictive analytics to foresee the root cause of issues, organizations can significantly reduce the time and resources required to resolve problems. This proactive approach not only helps reduce downtime but also ensures uninterrupted service, leading to higher customer satisfaction. Additionally, by promptly identifying and resolving underlying issues, organizations can meet their service level agreements (SLAs) and maintain high levels of performance and reliability. Ultimately, this innovation enhances operational efficiency, lowers risks, and supports a more robust and flexible IT infrastructure.

### § 8.3 Process for Intelligent Network Incident Management, RCA, and Automated Remediation

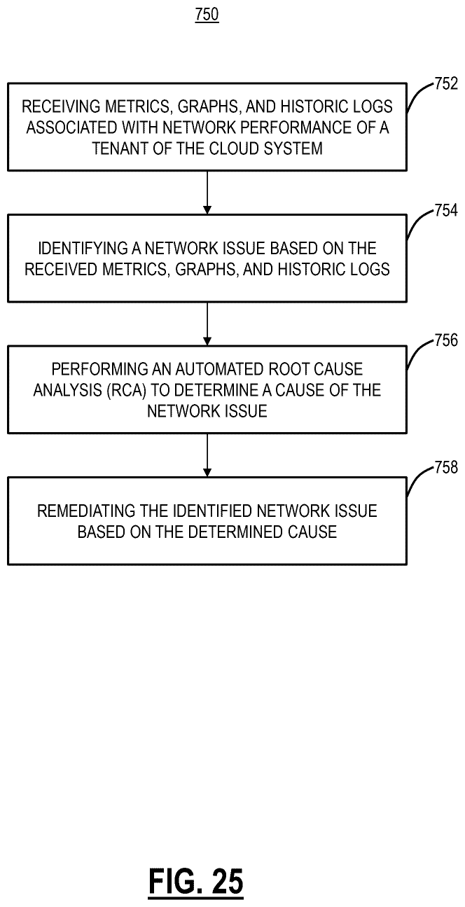

FIG. 25 is a flow chart of a process 750 for performing intelligent network incident management, root cause analysis, and automated remediation. The process 750 can be contemplated as a method having steps, a processing device configured to implement the steps, a cloud-based system configured to implement the steps, and as a non-transitory computer-readable medium storing instructions for programming one or more processors to execute the steps. The process 750 includes receiving metrics, graphs, and historic logs associated with network performance of a tenant of the cloud system (step 752); identifying a network issue based on the received metrics, graphs, and historic logs (step 754); performing an automated Root Cause Analysis (RCA) to determine a cause of the network issue (step 756); and remediating the identified network issue based on the determined cause (step 758).

The process 750 can further include wherein the graphs include metric trends over a period of time. The remediation can be performed automatically based on one or more remediation scripts. Identifying the network issue can be based on one or more metric thresholds. The one or more metric thresholds can be dynamic, wherein the steps include adjusting the one or more metric thresholds via a trained Large Language Model (LLM). The metrics, graphs, and historic logs can be received from one or more cloud connectors. The one or more cloud connectors can be associated with any of computing devices and enterprise networks. The identifying a network issue, performing automated RCA, and remediating can each be performed by one or more trained Large Language Models (LLMs). The steps can include training a first LLM to perform automated identification of network issues; training a second LLM to perform automated RCA; and training a third LLM to perform automated remediation of identified network issues. The tenant can be one of a plurality of tenants of the cloud system, wherein the one or more LLMs are trained based on tenant-specific metrics, graphs, and historic logs.

### § 9.0 Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method implemented by a cloud system comprising steps of:
receiving metrics, graphs, and historic logs associated with network performance of a tenant of the cloud system;
identifying a network issue based on the received metrics, graphs, and historic logs;
performing an automated Root Cause Analysis (RCA) to determine a cause of the network issue; and
remediating the identified network issue based on the determined cause.

2. The method of claim 1, wherein the graphs comprise metric trends over a period of time.

3. The method of claim 1, wherein the remediation is performed automatically based on one or more remediation scripts.

4. The method of claim 1, wherein identifying the network issue is based on one or more metric thresholds.

5. The method of claim 4, wherein the one or more metric thresholds are dynamic, and wherein the steps comprise adjusting the one or more metric thresholds via a trained Large Language Model (LLM).

6. The method of claim 1, wherein the metrics, graphs, and historic logs are received from one or more cloud connectors.

7. The method of claim 6, wherein the one or more cloud connectors are associated with any of computing devices and enterprise networks.

8. The method of claim 1, wherein the identifying a network issue, performing automated RCA, and remediating are each performed by one or more trained Large Language Models (LLMs).

9. The method of claim 8, wherein the steps comprise:
training a first LLM to perform automated identification of network issues;
training a second LLM to perform automated RCA; and
training a third LLM to perform automated remediation of identified network issues.

10. The method of claim 9, wherein the tenant is one of a plurality of tenants of the cloud system, and wherein the one or more LLMs are trained based on tenant-specific metrics, graphs, and historic logs.

11. A non-transitory computer-readable medium comprising instructions that, when executed, cause one or more processors associated with a cloud system to perform steps of:
receiving metrics, graphs, and historic logs associated with network performance of a tenant of the cloud system;
identifying a network issue based on the received metrics, graphs, and historic logs;
performing an automated Root Cause Analysis (RCA) to determine a cause of the network issue; and
remediating the identified network issue based on the determined cause.

12. The non-transitory computer-readable medium of claim 11, wherein the graphs comprise metric trends over a period of time.

13. The non-transitory computer-readable medium of claim 11, wherein the remediation is performed automatically based on one or more remediation scripts.

14. The non-transitory computer-readable medium of claim 11, wherein identifying the network issue is based on one or more metric thresholds.

15. The non-transitory computer-readable medium of claim 14, wherein the one or more metric thresholds are dynamic, and wherein the steps comprise adjusting the one or more metric thresholds via a trained Large Language Model (LLM).

16. The non-transitory computer-readable medium of claim 11, wherein the metrics, graphs, and historic logs are received from one or more cloud connectors.

17. The non-transitory computer-readable medium of claim 16, wherein the one or more cloud connectors are associated with any of computing devices and enterprise networks.

18. The non-transitory computer-readable medium of claim 11, wherein the identifying a network issue, performing automated RCA, and remediating are each performed by one or more trained Large Language Models (LLMs).

19. The non-transitory computer-readable medium of claim 18, wherein the steps comprise:
training a first LLM to perform automated identification of network issues;
training a second LLM to perform automated RCA; and
training a third LLM to perform automated remediation of identified network issues.

20. The non-transitory computer-readable medium of claim 19, wherein the tenant is one of a plurality of tenants of the cloud system, and wherein the one or more LLMs are trained based on tenant-specific metrics, graphs, and historic logs.
